(19) United States
(12) Patent Application Publication
(10) Pub. No.: US 2007/0017979 A1
(43) Pub. Date: Jan. 25, 2007

(54) Mobile ticketing via information hiding

(75) Inventors: Qzen-Zong Wu, Yang-Mei (TW); Yuang-Tzong Lan, Yang-Mei (TW); Wei-Herng Jeng, Yang-Mei (TW)

Correspondence Address: HDSL, 4331 STEVENS BATTLE LANE, FAIRFAX, VA, 22033, US

(73) Assignee: Chunghwa Telecom Co., Ltd.

(21) Appl. No.: 11/187,876

(22) Filed: Jul. 25, 2005

(51) Int. Cl. G06K 5/00

(52) U.S. Cl. 235/382

(57) ABSTRACT

A information-hidden mobile ticketing system, having a ticket purchasing device, an mobile ticket issuance management system, a embedded mobile ticket, a mobile communication device, and a ticket verification device. The user can purchase a mobile ticket from the mobile ticket issuance management system via the ticket purchasing device. Once the purchasing information is provided, the mobile ticket can be sent in the form of a message, a multi-medium message or other wireless form to a mobile communication device assigned by the purchaser. The information hiding method is used to embed the barcode representing the mobile ticket in a digital image. By a program specified by the mobile communication device, the digital image can be retrieved. Thereby, the risk of being decoded and stolen can be alleviated.

### BACKGROUND OF THE INVENTION

1. Field of Invention

The present invention relates in general to an mobile ticketing via information hiding, and more particularly, to an information-hidden mobile ticketing system which embeds the mobile ticket information into a digital image, which can only be retrieved and converted to an mobile ticket comprising such information in an assigned mobile communication device by a specific program.

2. Description of the Prior Art

A mobile ticket is typically presented by a barcode, a combination of text and symbol, or an image. By downloading the mobile ticket from a mobile communication device at the user end, the mobile ticket in the form of barcode, image or text, group of number can be easily retrieved. Therefore, the mobile ticket is easily illegally copied or used.

### SUMMARY OF THE INVENTION

An information-hidden mobile ticketing system which embeds the mobile ticket information in a digital image to avoid illegal copy or use of the mobile ticket is provided.

The information-hidden mobile ticketing system includes a ticket purchasing device, a mobile ticket issuance management system, an embedded mobile ticket, a mobile communication device, and a ticket verification device. The user can purchase an mobile ticket from the mobile ticket issuance management system via the ticket purchasing device. Once the purchasing information is provided, the mobile ticket can be sent in the form of a message, a multi-medium message or other wireless form to a mobile communication device assigned by the purchaser. The information hiding method is used to embed the barcode representing the electronic ticket into a digital image. By a program specified by the mobile communication device, the digital image can be retrieved. Thereby, the risk of being illegally decoded and stolen can be alleviated.

### BRIEF DESCRIPTION OF THE DRAWINGS

The present invention will become more fully understood from the detailed description given herein below illustration only, and thus are not limitative of the present invention, and wherein:

FIG. 1 shows the structure of an information-hidden mobile ticketing system; and

FIG. 2 shows an exemplary mobile ticket with embedded information.

### DETAILED DESCRIPTION OF THE PREFERRED EMBODIMENT

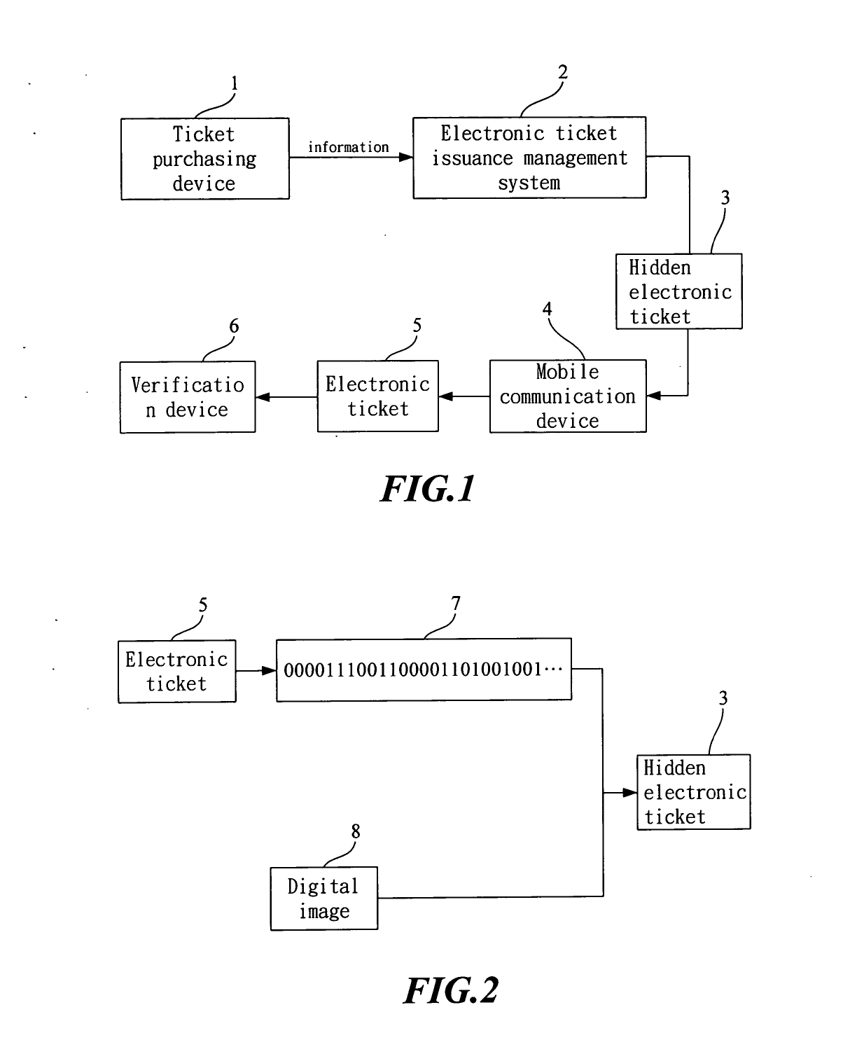

Referring to FIG. 1, the structure of an information-hidden mobile ticketing system is illustrated. The user purchases ticket via a ticket purchasing device 1. Once the ticket is purchased, the mobile ticket issuance management system 2 generates mobile ticket data according to purchasing information and embeds the mobile ticket data into an image, such that an embedded mobile ticket 3 is generated. The embedded mobile ticket 3 is then sent in the form of message, multi-medium message or other wireless form to a mobile communication device 4 assigned by the purchaser. When the purchaser intends to use or retrieve the mobile ticket, a specific program can be downloaded to the mobile communication device 4. The embedded mobile ticket can be recovered to a mobile ticket 5 and verified by a verification device 6.

Referring to FIG. 2, the embedded mobile ticket is illustrated. When the mobile ticket 5 is generated by the mobile ticket issuance management system 2 according to the purchasing information provided by the purchaser, the mobile ticket 5 is converted into a binary text string 7 and embedded in a digital image 8 by information hiding technique. For example, the mobile ticket 5 can be embedded in a manufacture trademark image to form the mobile ticket with embedded information 3. The mobile ticket information may include text, symbol, image, barcode or a combination thereof. In this embodiment, the binary text string is rearranged, and the lowest bit of each pixel byte of the digital image is replaced by the rearranged binary bit of the mobile ticket 5. The digital image is then delivered to the assigned mobile communication device 4 by the mobile ticket issuance management system. By a decoding program downloaded to the mobile communication device 4, the digital image can be decoded and converted into the mobile ticket with high security. In this embodiment, the decoding program reads the lowest bit of all the pixel bytes of the embedded mobile ticket 3 first, and perform reverse rearrangement to recover the binary text string of the mobile ticket 5, so as to retrieve the image of the mobile ticket.

The mobile ticketing system via information hiding is advantageous in the following aspects.

Firstly, the information hiding technique is used to embed mobile ticket information in a digital image. The mobile ticket information can only be decoded by a specific program provided by the ticket issuer.

Secondly, various information hiding techniques can be applied to avoid illegal decoding or steal.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An information-hidden mobile ticketing system, including a purchasing device, a mobile ticket issuance management system, a embedded-mobile ticket, a mobile communication device, and a verification device, wherein the mobile ticket issuance management system is operative to generate a embedded mobile ticket when a purchase request by a purchaser is received by the purchasing device and send the embedded mobile ticket to the mobile communication device assigned by the purchaser.

2. The system of claim 1, wherein the mobile ticket issuance management system is operative to generate an mobile ticket and embed the mobile ticket in a digital image to form the embedded mobile ticket.

3. The system of claim 2, wherein the embedded mobile ticket includes any or any combination of text, symbol, image and barcode.

4. The system of claim 2, wherein the embedded mobile ticket is converted into a binary text string and embedded in the digital image via an information hiding technique.

5. The system of claim 4, wherein the binary text string is rearranged to replace a lowest bit of each pixel byte of the digital image.

6. The system of claim 1, wherein the embedded mobile ticket can be recovered only by a program specified by the mobile ticket issuance management system and downloaded to the mobile communication device.

7. The system of claim 6, wherein the specified program is operative to decode the embedded mobile ticket encoded by one or more than one information hiding techniques.

8. The system of claim 1, wherein the embedded mobile ticket can be sent to the mobile communication device in the form of a text message, a multi-medium message or other wireless transmission form.
